(19) United States
(12) Patent Application Publication
(10) Pub. No.: US 2024/0054685 A1
(43) Pub. Date: Feb. 15, 2024

(54) POINT CLOUD DECODING METHOD, POINT CLOUD ENCODING METHOD, AND POINT CLOUD DECODING DEVICE

(71) Applicant: GUANGDONG OPPO MOBILE TELECOMMUNICATIONS CORP., LTD., Dongguan (CN)

(72) Inventors: Hui YUAN, Dongguan (CN); Weiwei WANG, Dongguan (CN); Tingting WANG, Dongguan (CN); Ming LI, Dongguan (CN)

(21) Appl. No.: 18/494,078

(22) Filed: Oct. 25, 2023

Related U.S. Application Data
(63) Continuation of application No. PCT/CN2021/090753, filed on Apr. 28, 2021.

(51) Int. Cl. G06T 9/00; G06T 3/00; G06T 5/00

(52) U.S. Cl. CPC G06T 9/001; G06T 3/0031; G06T 5/001; G06T 2207/20084

(57) ABSTRACT

A point cloud decoding method, a point cloud encoding method, and a point cloud decoding device are provided in embodiments of the disclosure. A point cloud bitstream is decoded to output a point cloud, where the point cloud includes attribute data and geometry data. Multiple three-dimensional patches are extracted from the point cloud. The extracted multiple three-dimensional patches are converted into two-dimensional pictures. Quality enhancement is performed on attribute data of the converted two-dimensional pictures, and the attribute data of the point cloud is updated according to the attribute data of the two-dimensional pictures after quality enhancement.

### CROSS-REFERENCE TO RELATED APPLICATION(S)

This application is a continuation of International Application No. PCT/CN2021/090753, filed Apr. 28, 2021, the entire disclosure of which is hereby incorporated by reference.

### TECHNICAL FIELD

Embodiments of the disclosure relate to, but are not limited to, the point cloud processing technology, in particular to a point cloud decoding method, a point cloud encoding method, and a point cloud decoding device.

### BACKGROUND

A point cloud is a set of massive points that express spatial distribution and surface feature of an object in the same spatial reference system. After obtaining spatial coordinates of each sampling point on the surface of the object, a set of points in a three-dimensional space is obtained, which is called “point cloud”. The point cloud can be directly obtained by measurement, and the point cloud obtained by photogrammetry includes three-dimensional coordinates and color information.

The digital video compression technology can reduce bandwidth and traffic pressure of point cloud data transmission, but it will also bring loss of picture quality.

### SUMMARY

Embodiments of the disclosure further provide a point cloud decoding method. The method includes the following. A point cloud bitstream is decoded to output a point cloud, where the point cloud includes attribute data and geometry data. Multiple three-dimensional patches are extracted from the point cloud. The extracted multiple three-dimensional patches are converted into two-dimensional pictures. Quality enhancement is performed on attribute data of the converted two-dimensional pictures, and the attribute data of the point cloud is updated according to the attribute data of the two-dimensional pictures after quality enhancement.

Embodiments of the disclosure further provide a point cloud encoding method. The method includes the following. Multiple three-dimensional patches are extracted from the point cloud, where the point cloud includes attribute data and geometry data. The extracted multiple three-dimensional patches are converted into two-dimensional pictures. Quality enhancement is performed on attribute data of the converted two-dimensional pictures, and the attribute data of the point cloud is updated according to the attribute data of the two-dimensional pictures after quality enhancement. The point cloud with the updated attribute data is encoded, and a point cloud bitstream is output.

Embodiments of the disclosure further provide a point cloud decoding device. The point cloud decoding device includes at least one processor and a memory. The memory is coupled to the at least one processor and stores at least one computer executable instruction thereon. When executed by the at least one processor, the at least one computer executable instruction causes the at least one processor to execute the point cloud decoding method of embodiments of the disclosure.

### BRIEF DESCRIPTION OF THE DRAWINGS

The accompanying drawings are used to provide an understanding of embodiments of the disclosure, and constitute a part of the specification, and together with embodiments of the disclosure, serve to explain technical solutions of the disclosure, and are not limiting to the technical solutions of the disclosure.

FIG. 1 is a schematic structural diagram of a point cloud encoding framework.

FIG. 2 is a schematic structural diagram of a point cloud decoding framework.

FIG. 3 is a flowchart of a method for quality enhancement of a point cloud according to an embodiment of the disclosure.

FIG. 4 is a schematic structural diagram of a system for performing quality enhancement on a point cloud at a decoding end according to an embodiment of the disclosure.

FIG. 5 is a structural diagram of units of a device for quality enhancement of a point cloud in FIG. 4.

FIG. 6 is a schematic structural diagram of a system for performing quality enhancement on a point cloud at an encoding end according to an embodiment of the disclosure.

FIG. 7A, FIG. 7B, and FIG. 7C are schematic diagrams of three scan modes adopted in an embodiment of the disclosure.

FIG. 8 is a flowchart of a method for determining a parameter of a quality enhancement network according to an embodiment of the disclosure.

FIG. 9 is a flowchart of a point cloud decoding method according to an embodiment of the disclosure.

FIG. 10 is a flowchart of a point cloud encoding method according to an embodiment of the disclosure.

FIG. 11 is a flowchart of a point cloud encoding method according to another embodiment of the disclosure.

FIG. 12 is a schematic structural diagram of a device for quality enhancement of a point cloud according to another embodiment of the disclosure.

FIG. 13 is a schematic structural diagram of a quality enhancement network for a point cloud according to an embodiment of the disclosure.

### DETAILED DESCRIPTION

Multiple embodiments are described in the disclosure, but the description is exemplary rather than limiting, and it will be apparent to those of ordinary skill in the art that more embodiments and implementations may be included within the scope of the embodiments described in the disclosure.

In the description of the disclosure, the words “exemplary” or “for example” are used as examples, illustrations, or explanations. Any embodiment described in the disclosure as “exemplary” or “for example” should not be construed as being more preferred or advantageous than other embodiments. Herein, “and/or” is a description of the association relationship of associated objects, indicating that there can be three relationships, for example, A and/or B, which can mean that there are three situations: only A, both A and B, and only B. “Multiple” means two or more. In addition, to clearly describe the technical proposal of the embodiment of the disclosure, the words “first”, “second”, and the like are used to distinguish the same items or similar items with substantially the same functions and functions. Those skilled in the art will appreciate that the words “first”, “second”, and the like are not limited in number or order of execution, and that the words “first”, “second”, and the like are not limited to any difference.

In describing representative embodiments, the specification may have presented the method and/or process as a particular sequence of steps. However, to the extent that the method or process does not depend on the particular order of the steps described herein the method or process should not be limited to the particular order of steps. As will be understood by those of ordinary skill in the art, other sequences of steps are also possible. Accordingly, the particular sequence of steps set forth in the specification should not be construed as limiting the claims. Furthermore, the claims for the method and/or process should not be limited to the steps of performing them in the written order, which can be readily understood by those skilled in the art and which can vary and remain within the spirit and scope of the embodiments of the disclosure.

A point cloud is a three-dimensional representation of a surface of an object. Point cloud data of the surface of the object can be collected by photoelectric radar, laser radar, laser scanner, multi-view camera and other acquisition device.

The point cloud refers to a set of massive three-dimensional points, and points in the point cloud can include position information of the points and attribute information of the points. Herein, the position information of the points in point cloud can also be called geometry information or geometry data of the point cloud, and the attribute information of the points in point cloud can also be called attribute data of the point cloud. For example, the position information of the point may be three-dimensional coordinate information of the point. For example, the attribute information of the point includes but is not limited to one or more of color information, reflection intensity, transparency, and normal vector. The color information may be information in any color space. For example, the color information may be expressed as colors (RGB) of three channels of red, green, and blue. For another example, the color information may be expressed as luminance-chrominance information (YCbCr, YUV), where Y represents luminance (Luma), Cb (U) represents blue chrominance, and Cr (V) represents red chrominance.

For example, a point in a point cloud obtained according to a laser measurement principle may include three-dimensional coordinate information of the point and laser reflection intensity of the point. In another example, a point in a point cloud obtained according to a photographic measurement principle may include three-dimensional coordinate information of the point and color information of the point. In still another example, a point in a point cloud obtained according to a combination of the laser measurement principle and the photographic measurement principle may include the three-dimensional coordinate information of the point, the laser reflection intensity of the point, and the color information of the point.

For example, according to the acquisition way, the point cloud may include a first type of static point cloud, a second type of dynamic point cloud, and a third type of dynamically-acquired point cloud.

For the first type of static point cloud, the object is stationary, and the device for acquiring the point cloud is also stationary.

For the second type of dynamic point cloud, the object is moving, but the device for acquiring the point cloud is stationary.

For the third type of dynamically-acquired point cloud, the device for acquiring the point cloud is moving.

For example, according to the purpose, the point cloud includes two types.

Type 1: machine-perceived point cloud, for autonomous navigation system, real-time inspection system, geographic information system, visual sorting robot, rescue and disaster relief robot, and other point cloud embodiment scenes.

Type 2: human-eye-perceived point cloud, for digital cultural heritage, free viewpoint broadcasting, three-dimensional immersion communication, three-dimensional immersion interaction, and other point cloud embodiment scenes.

Because the point cloud is a set of massive points, storing the point cloud consumes a large amount of memory and is not conducive to transmission, and there is no such large bandwidth to support the point cloud to be directly transmitted at the network layer without compression, so it is necessary to compress the point cloud.

For now, the point cloud may be compressed through a point cloud encoding framework.

The point cloud encoding framework may be a geometry point cloud compression (G-PCC) encoding and decoding framework or a video point cloud compression (V-PCC) encoding and decoding framework provided by the moving picture experts group (MPEG), or may be an AVS-PCC encoding and decoding framework provided by the audio video standard (AVS). The G-PCC encoding and decoding framework may be used for compression for the first static point cloud and the third type of dynamically-acquired point cloud, and the V-PCC encoding and decoding framework may be used for compression for the second type of dynamic point cloud. The G-PCC encoding and decoding framework is also called a point cloud codec TMC13, and the V-PCC encoding and decoding framework is also called a point cloud codec TMC2.

A point cloud encoding and decoding framework applicable to embodiments of the disclosure is described below in terms of the G-PCC encoding and decoding framework.

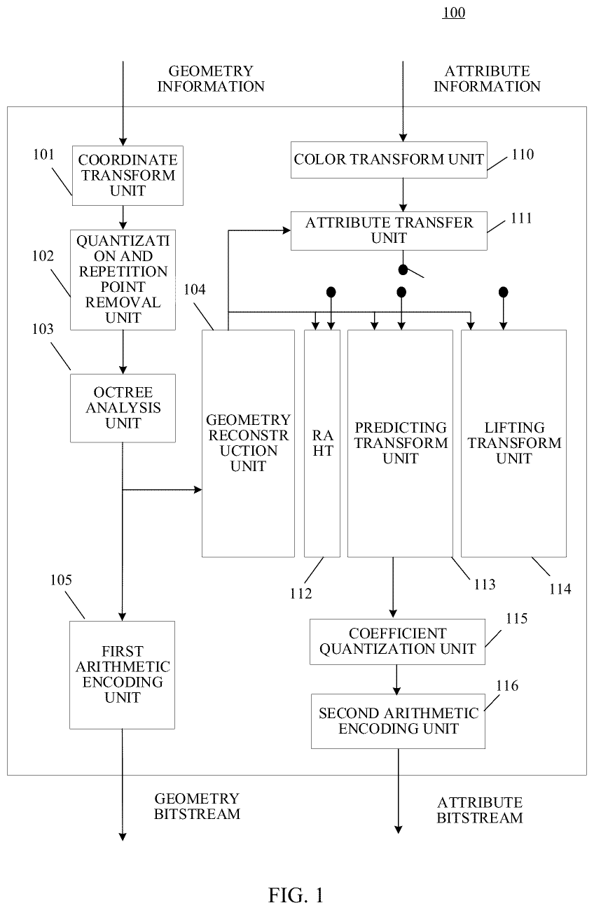

FIG. 1 is a schematic block diagram of an encoding framework 100 provided in embodiments of the disclosure.

As illustrated in FIG. 1, the encoding framework 100 can obtain position information and attribute information of a point cloud from an acquisition device. The encoding of the point cloud includes position encoding and attribute encoding. In one embodiment, the process of position encoding includes: performing preprocessing such as coordinate transformation and quantization and removal of repetition points on the original point cloud, and performing encoding after constructing an octree, to form a geometry bitstream.

The process of attribute encoding includes: by giving reconstructed information of position information of the input point cloud and actual values of attribute information of the input point cloud, selecting one of three prediction modes for point cloud prediction, quantizing the predicted result, and performing arithmetic encoding, to form an attribute bitstream.

As illustrated in FIG. 1, the position encoding can be achieved with the following units: a coordinate transform unit 101, a quantization and repetition point removal unit 102, an octree analysis unit 103, a geometry reconstruction unit 104, and a first arithmetic encoding unit 105.

The coordinate transform unit 101 can be used to transform world coordinates of points in the point cloud to relative coordinates. For example, the minimum values of coordinate axes x, y, and z are respectively subtracted from geometry coordinates of the point, which is equivalent to a de-direct current operation, to transform coordinates of the point in the point cloud from world coordinates to relative coordinates.

The quantization and repetition point removal unit 102 can be used to reduce the number of coordinates through quantization. After quantization, originally different points may be given the same coordinates, and based on this, repetition points may be removed by a de-duplication operation. For example, multiple points with the same quantization position and different attribute information may be merged into one point through attribute transformation. In some embodiments of the disclosure, the quantization and repetition point removal unit 102 is an optional unit module.

The octree analysis unit 103 can encode position information of quantized points through octree encoding. For example, the point cloud is partitioned in the form of an octree, so that positions of the points may be in a one-to-one correspondence with points of the octree. Positions of occupied nodes in the octree are determined and flags thereof are set to 1, to perform geometry encoding.

The first arithmetic encoding unit 105 can perform arithmetic encoding on the position information output from the octree analysis unit 103 through entropy encoding, i.e., the geometry bitstream is generated through arithmetic encoding by using the position information output from the octree analysis unit 103. The geometry bitstream can also be called a geometry code stream.

The attribute encoding can be achieved with the following units: a color transform unit 110, an attribute transfer unit 111, a region adaptive hierarchical transform (RAHT) unit 112, a predicting transform unit 113, and a lifting transform unit 114, a coefficient quantization unit 115, and a second arithmetic encoding unit 116.

The color transform unit 110 can be used to transform an RGB color space of the points in the point cloud to YCbCr format or other formats.

The attribute transfer unit 111 can be used to transform the attribute information of the points in the point cloud to minimize attribute distortion. For example, the attribute transfer unit 111 may be used to obtain actual values of the attribute information of the points. For example, the attribute information may be color information of the points.

After the actual values of the attribute information of the points are obtained through transformation of the attribute transfer unit 111, any prediction unit can be selected to predict the points in the point cloud. The prediction unit may the RAHT unit 112, the predicting transform unit 113, and the lifting transform unit 114. In other words, any of the RAHT unit 112, the predicting transform unit 113, and the lifting transform unit 114 can be used to predict attribute information of a point in the point cloud to obtain a prediction value of the attribute information of the point, and further obtain a residual value of the attribute information of the point based on the prediction value of the attribute information of the point. For example, the residual value of the attribute information of the point may be the actual value of the attribute information of the point minus the prediction value of the attribute information of the point.

The predicting transform unit 113 can also be used to generate a level of detail (LOD). The generation process of the LOD includes: obtaining Euclidean distances among the points according to the position information of the points in the point cloud, and partitioning the points into different LOD layers according to the Euclidean distances. In one embodiment, the Euclidean distances can be sorted and then points corresponding to different ranges of Euclidean distances are partitioned into different LOD layers. For example, a point can be randomly selected and classified into a first LOD layer. Then, Euclidean distances between remaining points and the point are calculated, and points whose Euclidean distances satisfy a first threshold are classified into a second LOD layer. The centroid of the points in the second LOD layer is obtained, Euclidean distances between points other than the first LOD layer and second LOD layer and the centroid is calculated, and points whose Euclidean distances satisfy a second threshold are classified into a third LOD layer. The above is continued until all points are classified into LOD layers. The threshold value of the Euclidean distance can be adjusted, so that the number of points in each LOD layer is increasing. It should be understood that, the LOD layer partition can be achieved in other ways, which is not limited in the disclosure. It should be noted that, in other embodiments the point cloud can be directly partitioned into one or more LOD layers, or the point cloud can be first partitioned into multiple point cloud slices, and each slice can be partitioned into one or more LOD layers. For example, the point cloud can be partitioned into multiple slices, and the number of points in each slice can range from 550,000 to 1.1 million. Each slice can be viewed as a separate point cloud. Each slice can be partitioned into multiple LOD layers, where each LOD layer includes multiple points. In one example, the LOD layer partition is based on the Euclidean distance among points.

The coefficient quantization unit 115 may be used to quantize the residual values of the attribute information of the points. For example, if the coefficient quantization unit 115 is connected with the predicting transform unit 113, the quantization unit may be used to quantize a residual value of attribute information of a point output from the predicting transform unit 113. For example, the residual value of the attribute information of the point output from the predicting transform unit 113 is quantized by using the quantization step size, to improve system performance.

The second arithmetic encoding unit 116 may perform entropy encoding on the residual value of the attribute information of the point using zero run length coding, to obtain the attribute bitstream. The attribute bitstream may be bitstream information.

In one embodiment, the prediction value (or called predicted value) of the attribute information of the point in the point cloud may also be called the predicted color in the LOD mode. The actual value of the attribute information of the point minus the prediction value of the attribute information of the point is the residual value of the point. The residual value of the attribute information of the point can also be called the residual color in the LOD mode. The prediction value of the attribute information of the point and the residual value of the attribute information of the point are added to obtain the reconstructed value of the attribute information of the point. In the embodiment, the reconstructed value of the attribute information of the point can also be called the reconstructed color in the LOD mode.

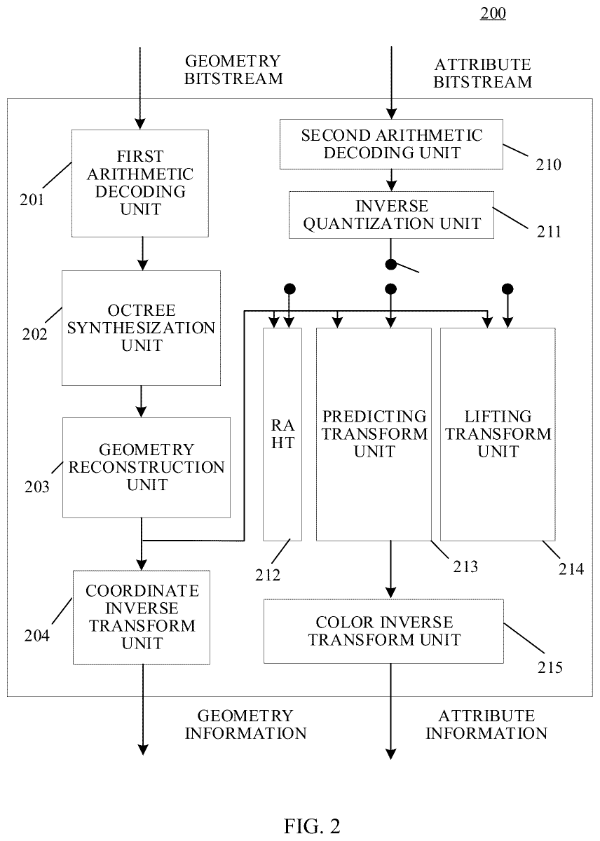

FIG. 2 is a schematic block diagram of a decoding framework 200 applicable to embodiments of the disclosure.

As illustrated in FIG. 2, the decoding framework 200 can obtain a bitstream of a point cloud generated by an encoding device and obtain position information and attribute information of points in the point cloud by parsing the bitstream. The decoding of the point cloud includes position decoding and attribute decoding. In one embodiment, the process of position decoding includes: performing arithmetic decoding on the geometry bitstream; performing synthetization after constructing an octree, and reconstructing the position information of the points, to obtain reconstructed information of the position information of the points; and performing coordinate transformation on the reconstructed information of the position information of the points to obtain the position information of the points. The position information of the points may also be referred to as geometry information of the points.

The process of attribute decoding includes: parsing the attribute bitstream to obtain residual values of the attribute information of the points in the point cloud; performing inverse quantization on the residual values of the attribute information of the points, to obtain residual values of the attribute information of the points after inverse quantization; based on the reconstructed information of the position information of the points obtained during position decoding, selecting one of the three prediction modes to perform point cloud prediction, to obtain reconstructed values of the attribute information of the points; and performing color space inverse transformation on the reconstructed values of the attribute information of the points, to obtain the decoded point cloud.

As illustrated in FIG. 2, the position decoding can be achieved with the following units: a first arithmetic decoding unit 201, an octree synthetization unit 202, a geometry reconstruction unit 203, and a coordinate inverse transform unit 204.

The attribute decoding can be achieved with the following units: a second arithmetic decoding unit 210, an inverse quantization unit 211, an RAHT unit 212, a predicting transform unit 213, a lifting transform unit 214, and a color inverse transform unit 215.

It should be noted that, decompression is the inverse process of compression, and similarly, functions of various units in the decoding framework 200 can be referred to the functions of corresponding units in the encoding framework 100.

For example, in the decoding framework 200, the point cloud can be partitioned into LODs based on Euclidean distances among points in the point cloud, and then attribute information of the points in the LODs is decoded sequentially. For example, the number of zeros (zero_cnt) in the zero run length coding technique is calculated, to decode the residual based on zero_cnt, and then in the decoding framework 200, inverse quantization may be performed on the decoded residual value, and a reconstructed value of the point is obtained by adding the residual value after inverse quantization and a prediction value of the current point, until all points are decoded. The current point will be used as the nearest neighbor of a subsequent point(s) in the LOD, and the reconstructed value of the current point will be used to predict attribute information of the subsequent point.

In the field of computer vision, quality enhancement plays an important role in improving video (or picture) quality and visual effect. Video (or picture) quality enhancement generally refers to improving the quality of the video (or picture) with quality loss. In the current communication system, video (or picture) transmission needs to go through the process of compression (or encoding), and in this process, the quality of the video (or picture) will be lost to some extent. Meanwhile, there is often noise in the transmission channel, which will also lead to the damage of video (or picture) quality after channel transmission. Therefore, the quality enhancement on the decoded video (or picture) can improve the quality of the video (or picture), and video (or picture) quality enhancement based on convolution neural network is an effective method. However, there is no corresponding solution to perform quality enhancement on the point cloud.

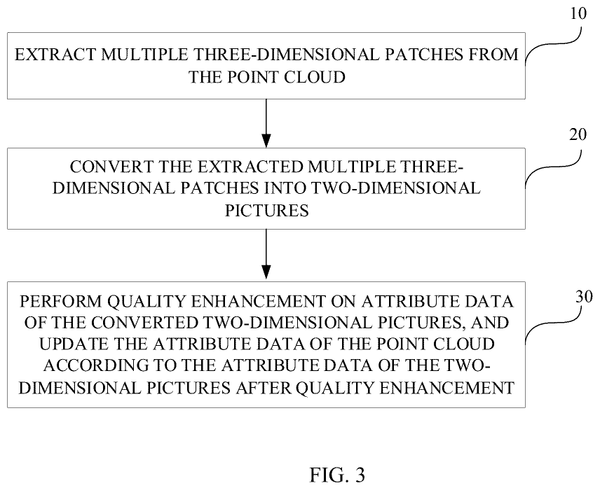

To this end, an embodiment of the disclosure provides a method for quality enhancement of a point cloud. As illustrated in FIG. 3, the method includes the following.

At block 10, multiple three-dimensional (3D) patches are extracted from the point cloud, where the point cloud includes attribute data and geometry data.

At block 20, the extracted multiple three-dimensional patches are converted into two-dimensional (2D) pictures.

At block 30, quality enhancement is performed on attribute data of the converted two-dimensional pictures, and the attribute data of the point cloud is updated according to the attribute data of the two-dimensional pictures after quality enhancement.

In some embodiments of the disclosure, the patch is a set of partial points in the point cloud. For example, if the point cloud is a set of three-dimensional points representing a surface of an object, the patch may be a set of three-dimensional points representing a piece of the surface of the object. In an example, one point in the point cloud is taken as the target point, and a specific number (e.g., 1023) of points nearest to the point in terms of Euclidean distance form one three-dimensional patch.

In embodiments of the disclosure, the method for quality enhancement of the point cloud converts the quality enhancement of the three-dimensional point cloud into the quality enhancement of the two-dimensional pictures. By extracting the three-dimensional patch and processing like conversion from three-dimensional to two-dimensional and combining with the method for quality enhancement of the two-dimensional pictures, the attribute data of the point cloud is updated according to the attribute data of the two-dimensional pictures after quality enhancement, achieving the quality enhancement of the three-dimensional point cloud.

In operation at block 10 of the embodiment, when extracting multiple three-dimensional patches from the point cloud, the three-dimensional patches may have some overlapping points, and it is not required that the extracted three-dimensional patches may form the complete point cloud (in other embodiments, it is required that the extracted three-dimensional patches may form the complete point cloud). That is, in the embodiment, some points in the point cloud do not exist in any three-dimensional patch, and attribute data of these points may remain unchanged when updating. The number and size of the three-dimensional patches extracted from the point cloud can be preset, or the number and size of the three-dimensional patches can be obtained by decoding the bitstream, or selected from multiple preset values according to the size of the current point cloud and the requirement of quality enhancement.

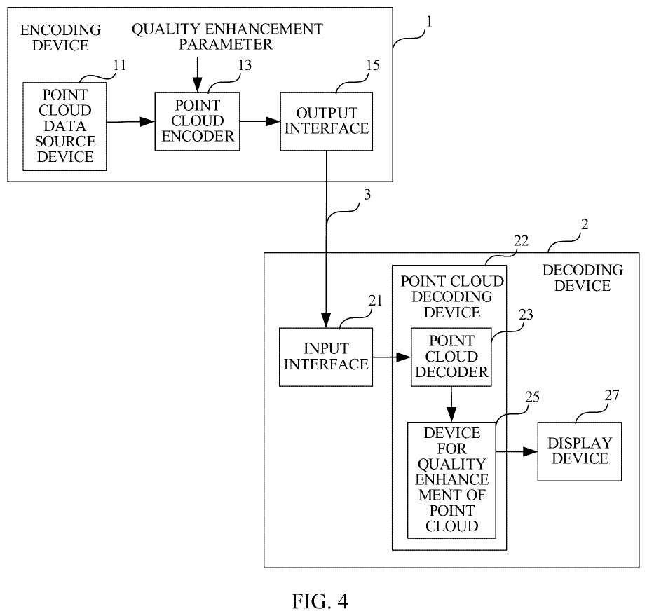

In an embodiment of the disclosure, the point cloud on which quality enhancement is performed is obtained from a point cloud decoder after decoding a point cloud bitstream, that is, the method for quality enhancement of the point cloud of embodiments of the disclosure can be used in the post-processing module of the decoder, and its input is the point cloud data obtained from the decoder by decoding the bitstream. A schematic block diagram of a corresponding point cloud encoding and decoding system is illustrated in FIG. 4.

The point cloud encoding and decoding system illustrated in FIG. 4 includes an encoding device 1 and a decoding device 2. The encoding device 1 generates encoded point cloud data (i.e., point cloud data that is encoded). The decoding device 2 can decode and perform quality enhancement on the encoded point cloud data. The encoding device 1 and the decoding device 2 may include one or more processors and a memory coupled to the one or more processors, such as random access memory, electrically erasable programmable read-only memory, flash memory, or other media. The encoding device 1 and the decoding device 2 may be implemented with various devices, such as a desktop computer, a mobile computing device, a notebook computer, a tablet computer, a set-top box, a television, a camera, a display device, a digital media player, a vehicle-mounted computer, or the like.

The decoding device 2 may receive the encoded point cloud data from the encoding device 1 via a link 3. The link 3 includes one or more media or devices capable of transferring the encoded point cloud data from the encoding device 1 to the decoding device 2. In one example, the link 3 may include one or more communication media that enable the encoding device 1 to transmit the encoded point cloud data directly to the decoding device 2 in real time. The encoding device 1 may modulate the encoded point cloud data according to a communication standard (e.g. a wireless communication protocol) and may transmit the modulated point cloud data to the decoding device 2. The one or more communication media may include wireless and/or wired communication media such as radio frequency (RF) spectrum or one or more physical transmission lines. The one or more communication media may form part of a packet-based network such as a local area network, a wide area network, or a global network (e.g. the Internet). The one or more communication media may include a router, a switch, a base station, or other devices that facilitate communication from the encoding device 1 to the decoding device 2. In another example, the encoded point cloud data may also be output from an output interface 15 to a storage device, and the decoding device 2 may read from the storage device the stored point cloud data via streaming or downloading. The storage device may include any of multiple distributed or locally accessed data storage media, such as a hard disk drive, Blu-ray disc, digital versatile disc, read-only disc, flash memory, transitory or non-transitory memory, file server, and the like.

In the example illustrated in FIG. 4, the encoding device 1 includes a point cloud data source device 11, a point cloud encoder 13, and the output interface 15. In some examples, the output interface 15 may include a regulator, a modem, and a transmitter. The point cloud data source device 11 may include a point cloud capture device (e.g. a camera), a point cloud archive containing previously captured point cloud data, a point cloud feed interface for receiving point cloud data from a point cloud content provider, a graphics system for generating point cloud data, or a combination of these sources. The point cloud encoder 13 may encode the point cloud data from the point cloud data source device 11. In an example, the point cloud encoder 13 is implemented with the point cloud encoding framework 100 illustrated in FIG. 1, but the disclosure is not limited thereto.

In the embodiment illustrated in FIG. 4, the decoding device 2 includes an input interface 21, a point cloud decoder 23, a device 25 for quality enhancement of the point cloud, and a display device 27. In some examples, the input interface 21 includes at least one of a receiver or a modem. The input interface 21 may receive the encoded point cloud data via the link 3 or from the storage device. The display device 27 is used for displaying the decoded and quality-enhanced point cloud data and may be integrated with other devices of the decoding device 2 or provided separately. The display device 27 may for example be a liquid crystal display, a plasma display, an organic light emitting diode display, or other type of display device. In other examples, the decoding device 2 may not include the display device 27, but include other devices or apparatuses for applying the point cloud data. In an example, the point cloud decoder 23 may be implemented with the point cloud decoding framework 200 illustrated in FIG. 2, but the disclosure is not limited thereto. In the embodiment illustrated in FIG. 4, the point cloud decoding device 22 includes the point cloud decoder 23 and the device 25 for quality enhancement of the point cloud. The point cloud decoder 23 is arranged to decode the point cloud bitstream and the device 25 for quality enhancement of the point cloud is arranged to enhance the quality of the point cloud output from the point cloud decoder. Herein, the decoding should be understood in a broad sense, and the process of enhancing the quality of the point cloud output from the point cloud decoder is also regarded as a part of the decoding.

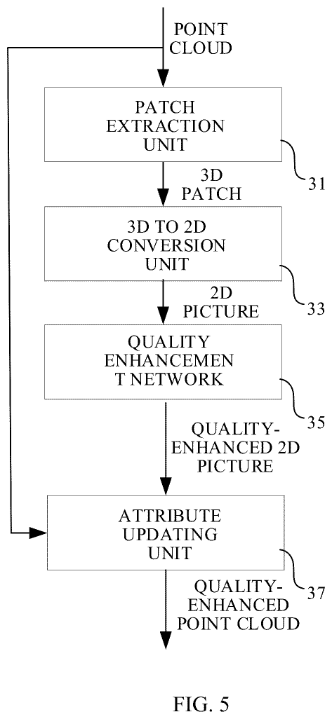

In an embodiment of the disclosure, a functional block diagram of the device 25 for quality enhancement of the point cloud is illustrated in FIG. 5. The point cloud decoder decodes the point cloud bitstream and then outputs the point cloud to a patch extraction unit 31 to extract multiple three-dimensional patches. The multiple three-dimensional patches are converted into two-dimensional pictures by a three-dimensional to two-dimensional conversion unit 33 and then sent to a point cloud quality enhancement network (such as trained convolutional neural network) 35. The quality enhancement network 35 outputs the quality-enhanced two-dimensional pictures, and in the attribute updating unit 37, the attribute data of the point cloud is updated with the attribute data of the quality-enhanced two-dimensional pictures, to obtain the quality-enhanced point cloud. The device 25 for quality enhancement of the point cloud or the point cloud decoding device 22 may be implemented using any of one or more microprocessors, digital signal processors, application specific integrated circuits, field programmable gate arrays, discrete logic, hardware, or any combination thereof. If the disclosure is implemented in part in software, the quality enhancement device may store instructions for the software in a suitable non-transitory computer-readable storage medium, and may implement the technology of the disclosure by executing the instructions in hardware using one or more processors. The device 25 for quality enhancement of the point cloud may be integrated with one or more of the point cloud decoder 23, the input interface 21, and the display device 27, or may be a separately provided device.

Based on the system illustrated in FIG. 4, in an embodiment of the disclosure, the point cloud encoder 13 in the encoding device performs lossy attribute encoding on the point cloud collected by the point cloud data source device 11. For example, the encoding mode of the lossless geometry and lossy color (i.e., lossy color attribute) under the point cloud standard encoding platform TMC given by MPEG is adopted. TMC13v9.0 provides six bit-rate points, which are r01˜r06 respectively, and the corresponding color quantization steps are 51, 46, 40, 34, 28, and 22 respectively. The device 25 for quality enhancement of the point cloud in the decoding device 2 performs quality enhancement on the point cloud output from the point cloud decoder 23. The device 25 for quality enhancement of the point cloud may perform quality enhancement on the decoded point cloud using the method for quality enhancement described in any embodiment of the disclosure. However, the disclosure is not limited to performing quality enhancement at the decoding end on the point cloud after lossy attribute encoding and decoding. In another embodiment, even if the point cloud encoder adopts lossless attribute encoding, quality enhancement can be performed at the decoding end on the decoded point cloud, to remove noise mixed in the bitstream during channel transmission or to achieve a desired visual effect.

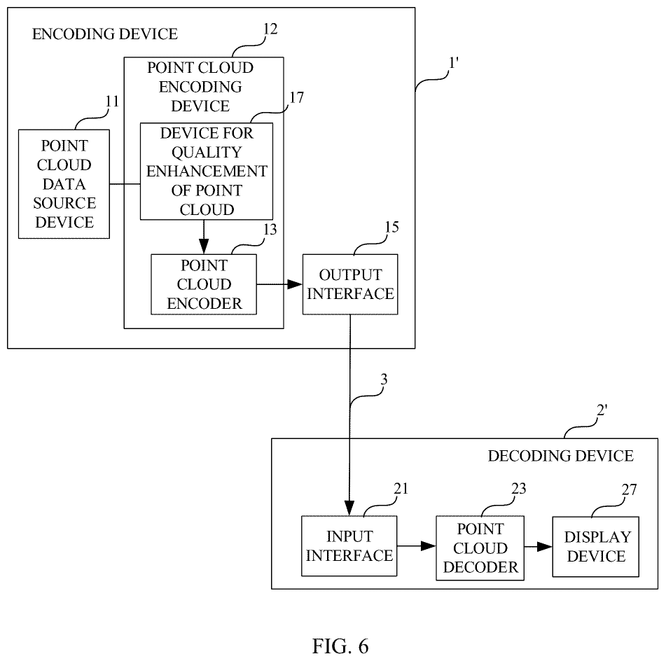

In the embodiment illustrated in FIG. 4, quality enhancement is performed on the point cloud after lossy attribute encoding and decoding. In another embodiment of the disclosure, quality enhancement is performed on the point cloud output by the point cloud data source device, that is, the method for quality enhancement of the point cloud of embodiments of the disclosure can be used for a pre-processing module of the point cloud encoder, with its input being the original point cloud data. The point cloud data source device may include, for example, a point cloud capture device, a point cloud archive containing previously captured point cloud data, a point cloud feed interface for receiving point cloud data from a point cloud content provider, a graphics system for generating point cloud data, or a combination of these sources. The quality enhancement of the original point cloud data can be, for example, removing noise, de-blurring, or achieving the desired visual effect. For example, a corresponding point cloud encoding and decoding system is illustrated in FIG. 6.

The main difference between the point cloud encoding and decoding system illustrated in FIG. 6 and the above point cloud encoding and decoding system illustrated in FIG. 4 is that: the device for quality enhancement of the point cloud is provided in the encoding device 1′, for performing quality enhancement on the point cloud output from the point cloud data source device. Other devices in the encoding device 1′ and the decoding device 2′ in FIG. 6 are described in the corresponding devices in FIG. 4 and are not repeated herein. The point cloud encoding device 12 in FIG. 6 includes a device 17 for quality enhancement of the point cloud and a point cloud encoder 13. The device 17 for quality enhancement of the point cloud is arranged to perform quality enhancement on the point cloud output from the point cloud data source device and the point cloud encoder 13 arranged to encode the quality-enhanced point cloud and output an encoded bitstream. The encoding herein is to be understood broadly and includes quality enhancement before encoding. The device 17 for quality enhancement of the point cloud or the point cloud encoding device 12 may be implemented using any of: one or more microprocessors, digital signal processors, application specific integrated circuits, field programmable gate arrays, discrete logic, hardware, or any combination thereof. If the disclosure is implemented in part in software, the quality enhancement device may store instructions for the software in a suitable non-transitory computer-readable storage medium, and may implement the technology of the disclosure by executing the instructions in hardware using one or more processors.

In another embodiment of the disclosure, one device for quality enhancement of the point cloud can be arranged in each of the encoding device and the decoding device of the point cloud encoding and decoding system. The device for quality enhancement of the point cloud in the encoding device is used for performing quality enhancement on the point cloud output from the point cloud data source device, and the device for quality enhancement of the point cloud in the decoding device is used for performing quality enhancement on the point cloud output from the point cloud decoder after decoding the point cloud bitstream.

In the method for quality enhancement of the point cloud of the embodiment illustrated in FIG. 3, when quality enhancement is performed on the point cloud, multiple attribute data (such as color attribute data and reflection intensity attribute data) of the point cloud may be lossy. In embodiments of the disclosure, when quality enhancement is performed on the attribute data of the converted two-dimensional picture, quality enhancement can be performed on only part of the attribute data. When the attribute data has multiple components, enhancement can also be performed on only part of the components of the attribute data. Accordingly, when updating the attribute data of the point cloud according to the attribute data of the two-dimensional pictures after quality enhancement, only part of the attribute data of the point cloud or part of the components of the attribute data may be updated. In an embodiment of the disclosure, the attribute data contains a luma component, and quality enhancement is performed on the attribute data of the converted two-dimensional pictures, and the attribute data of the point cloud is updated according to the attribute data of the two-dimensional pictures after quality enhancement as follows. Quality enhancement is performed on luma components of the converted two-dimensional pictures, and the luma component contained in the attribute data of the point cloud is updated according to the luma components of the two-dimensional pictures after quality enhancement. Although, in the embodiment, quality enhancement is performed on the luma component i.e., the Y component, in other embodiments, quality enhancement and attribute data updating may also be performed on one or more of other color components such as R, G, B, or one or more of Cb or Cr.

In an embodiment of the disclosure, for the operation at block 10, the multiple three-dimensional patches are extracted from the point cloud as follows. Multiple representative points in the point cloud are determined. A nearest neighbouring point for each of the multiple representative points is determined, where the nearest neighbouring point of one representative point denotes one or more points in the point cloud nearest to the representative point. The multiple three-dimensional patches are constructed based on the multiple representative points and the nearest neighbouring points of the multiple representative points. The points contained in the three-dimensional patch extracted according to the embodiment are points in the point cloud, and the geometry data and attribute data of the points are unchanged. The one or more representative points in the point cloud can be determined with a farthest point sampling (FPS) algorithm. The farthest point sampling algorithm is a uniform sampling method for the point cloud, and the collected representative points are evenly distributed in the point cloud, but the disclosure is not limited to this sampling algorithm. For example, other point cloud sampling methods such as grid sampling can also be used. In one example, representative points of a set number in the point cloud are determined with the FPS algorithm, where the set number can be 128, 256, 512, 1024, or other values. The nearest neighbouring points of each of the determined multiple representative points are found, where one representative point and its nearest neighbouring points can construct one three-dimensional patch. The number of the nearest neighbouring points of one representative point can be set as 511, 1023, 2047, or 4095, and correspondingly, the number of points contained in the three-dimensional patch is 512, 1024, 2048, or 4096. However, these numbers are merely exemplary, and the number of the nearest neighbouring points of one representative point can be set as other values. The distance from the point in the point cloud to the representative point can be measured by the Euclidean distance. The smaller the Euclidean distance from one point to one representative point, the closer the distance from the point to the representative point.

In an embodiment of the disclosure, for the operation at block 20, when converting the extracted multiple three-dimensional patches into the two-dimensional picture(s), the extracted three-dimensional patches can be converted into one or more two-dimensional pictures. When the extracted three-dimensional patches is converted into multiple two-dimensional pictures, each extracted three-dimensional patch is converted in the following way. The representative point in the three-dimensional patch is taken as a start point, scan on a two-dimensional plane in a predetermined scan mode, and other points in the three-dimensional patch are mapped to a scan path in an increasing order of Euclidean distances to the representative point, to obtain one or more two-dimensional pictures, where a point in the three-dimensional patch nearer to the representative point is nearer to the representative point on the scan path, and attribute data of all points after mapping are unchanged. In one example, the three-dimensional patch includes S1×S2 points, where S1 and S2 are positive integers greater than or equal to 2. The predetermined scan mode includes at least one of: square-spiral-shape scan, raster scan, or Z-shape scan. When converting one three-dimensional patch into one or more two-dimensional pictures, one scan mode can be used to convert one three-dimensional patch into one two-dimensional picture, or multiple scan modes can be used to convert one three-dimensional patch into multiple two-dimensional pictures. In this case, one point on the three-dimensional patch corresponds to multiple points in the two-dimensional pictures. Since one point on the three-dimensional patch is one point in the point cloud, one point in the point cloud has multiple corresponding points in the two-dimensional pictures. After quality enhancement on each of the two-dimensional pictures is performed, the attribute data of the point in the point cloud can be updated according to the weighted average value of the attribute data of the corresponding points after quality enhancement.

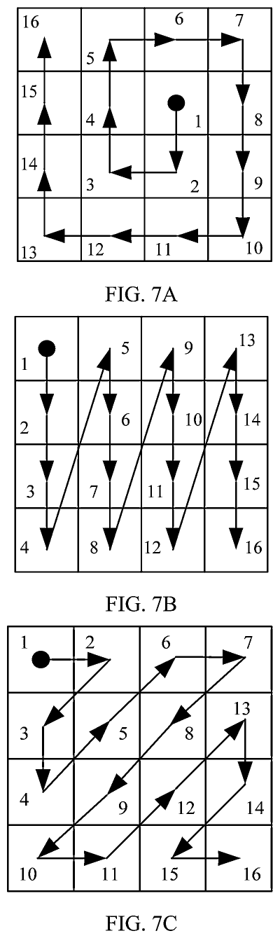

FIG. 7A, FIG. 7B, and FIG. 7C each are schematic diagrams of sequentially mapping points in a three-dimensional patch to a scan path in a self-defined scan mode. In the figures, the three-dimensional patch has 16 points, and by scanning, the 16 points are mapped to a two-dimensional picture with 4×4 points. In the figures, each small box represents a point, which can correspond to one pixel on the two-dimensional picture. The number in the small box of the point represent a mapping order. For example, the small box with the number 1 represents the 1st point mapped to the two-dimensional picture during scanning, that is, the representative point, and the small box with the number 2 represents the 2rd point mapped to the two-dimensional picture during scanning, and so on. According to the conversion method of the embodiment, after the representative point is mapped to a corresponding position of the two-dimensional picture (the representative point is mapped to the center of the two-dimensional picture in square-spiral-shape scan, and the representative point is mapped to the corner of the two-dimensional region in raster scan and Z-shape scan), the second point mapped to the two-dimensional picture is the point in the three-dimensional patch nearest to the representative point (i.e., the point with the smallest Euclidean distance to the representative point), the third point mapped to the two-dimensional picture is the point in the three-dimensional patch second nearest to the representative point, and so on. That is, during scanning, other points in the three-dimensional patch are mapped to the scan path in the increasing order of the Euclidean distances to the representative point. For example, according to the scan path, the point in the three-dimensional patch nearer to the representative point is nearer to the representative point on the scan path, and the earlier it is mapped to the two-dimensional picture during scanning. Herein, the points having mapping relationship in the three-dimensional patch and two-dimensional picture are called the corresponding points in the three-dimensional patch and two-dimensional picture.

The square-spiral-shape scan is illustrated in FIG. 7A, when scanning, rotate outward in clockwise or counterclockwise order with the representative point as the center until mapping of all the points in the three-dimensional patch is complete.

The raster scan may be a column scan mode as illustrated in FIG. 7B or a row scan mode. Scan points (such as S1 points) of a set number on a row or column, and then scan points (such as S1 points) of a set number on an adjacent row or column, until scanning of rows or columns (such as S2 rows or S2 columns, in this case the number of points in the three-dimensional patch is S1×S2) of a set number is completed.

The Z-shape scan is illustrated in FIG. 7C and will not be repeated herein.

Using two-dimensional pictures obtained by different scan modes as input data has certain influence on the quality enhancement effect achieved by the trained quality enhancement network. After testing, the trained quality enhancement network can achieve better quality enhancement effect when the three-dimensional patches are converted into the two-dimensional pictures in the Z-shape scan mode.

In another embodiment of the disclosure, the three-dimensional patches can be converted into the two-dimensional pictures in other ways, such as convolution operation FPConv. FPConv is a type of point cloud processing method based on representation of the surface of the object. In this method, nonlinear projection is learned for each patch and the points in the neighborhood are flattened into a two-dimensional grid plane, and then a two-dimensional convolution can be conveniently applied to feature extraction.

In an embodiment of the disclosure, for the operation at block 20, the extracted multiple three-dimensional patches are converted into one two-dimensional picture. In this case, the method of converting the extracted three-dimensional patches into the two-dimensional pictures of the above embodiment can also be adopted, and the multiple two-dimensional pictures converted from the multiple three-dimensional patches need to be spliced into one large two-dimensional picture, and the quality of the attribute data of the spliced two-dimensional picture is enhanced.

In an embodiment of the disclosure, quality enhancement is performed on the attribute data of the converted two-dimensional pictures as follows. Quality enhancement is performed on the attribute data of the converted two-dimensional pictures with a convolution neural network. In one example, for point clouds of different types, different quality enhancement networks, such as depth learning-based convolution neural networks, are trained, and before quality enhancement is performed on the attribute data of the two-dimensional pictures, the type of the point cloud is determined, and then the quality enhancement is performed on the attribute data of the two-dimensional pictures with the quality enhancement network corresponding to the determined type. The above types of the point clouds can include, for example, architecture, portrait, landscape, plant, furniture, etc., where one of the major type can be subdivided into multiple sub-types, for example, the type pf the portrait can be subdivided into child and adult, etc., without any limitation in the disclosure. In another example, for point clouds with different bit rates of attribute bitstreams, different quality enhancement networks are trained, and before quality enhancement is performed on the attribute data of the two-dimensional pictures, the bit rate of the attribute bitstream of the point cloud is determined, and then the quality enhancement is performed on the attribute data of the two-dimensional pictures with the quality enhancement network corresponding to the determined bit rate. For example, the bit rate of the attribute bitstream can be one of the six bit-rate points r01 to r06 provided by TMC13v9.0, and the corresponding color quantization step sizes are 51, 46, 40, 34, 28, and 22, respectively. In another example, both the type and the bit rate of the attribute stream of the point cloud can be determined, and then the quality enhancement is performed on the attribute data of the two-dimensional picture with the quality enhancement network corresponding to the determined type and bit rate of the attribute stream, where different quality enhancement networks are trained for different combinations of the type and encoding bit rate of the point cloud.

In an embodiment of the disclosure, the method for quality enhancement further includes the following. A quality enhancement parameter of the point cloud is determined, and quality enhancement is performed on the point cloud according to the determined quality enhancement parameter. The quality enhancement parameter includes at least one of: the number of the three-dimensional patches extracted from the point cloud; the number of points in each two-dimensional picture; arrangement of the points in each two-dimensional picture; at least one scan mode used when converting the multiple three-dimensional patches into the two-dimensional pictures; a parameter of a quality enhancement network, where the quality enhancement network is used for performing quality enhancement on the attribute data of the two-dimensional pictures; or a data feature parameter of the point cloud, where the data feature parameter is used for determining the quality enhancement network used in performing quality enhancement on the attribute data of the two-dimensional pictures. The data feature parameter of the point cloud includes at least one of: a type of the point cloud or a bit rate of an attribute bitstream of the point cloud. The type of the point cloud can be determined by the result of detection of the point cloud (such as texture complexity detection, etc.) at the decoding end, and when the parameter is encoded at the encoding end, the type of the point cloud can also be obtained by decoding the bitstream, or the type of the point cloud can also be set. The bit rate of the attribute bitstream of the point cloud can be determined by the point cloud decoder and then notified to the device for quality enhancement of the point cloud.

In an embodiment of the disclosure, the attribute data of the point cloud is updated according to the attribute data of the two-dimensional pictures after quality enhancement as follows. For each point in the point cloud, if the point has corresponding points in multiple quality-enhanced two-dimensional pictures, the attribute data of the point in the point cloud is set equal to a weighted average value of attribute data of the corresponding points in the multiple quality-enhanced two-dimensional pictures, where weights of different points can be set or be equal by default. The arithmetic mean value can be regarded as the weighted average value with equal weights. For each point in the point cloud, if the point only has a corresponding point in one quality-enhanced two-dimensional picture, the attribute data of the point in the point cloud is set equal to attribute data of the corresponding point in the quality-enhanced two-dimensional picture. For each point in the point cloud, if there is no corresponding point in all the quality-enhanced two-dimensional pictures, the attribute data of the point in the point cloud is not updated.

In an embodiment of the disclosure, the attribute data of the point cloud is updated according to the attribute data of the two-dimensional pictures after quality enhancement as follows. For each point in the point cloud, at least one corresponding point in the two-dimensional pictures after quality enhancement of the point is determined. Attribute data of the point in the point cloud is set to be equal to attribute data of the at least one corresponding point, when the number of the at least one corresponding point is 1. The attribute data of the point in the point cloud is set to be equal to a weighted average value of the attribute data of the at least one corresponding point, when the number of the at least one corresponding point is greater than 1. The attribute data of the point in the point cloud is not updated, when the number of the at least one corresponding point is 0 (i.e., the point does not have any corresponding point in all the two-dimensional pictures after quality enhancement).

For the method for quality enhancement of the point cloud in the embodiment of the disclosure, quality enhancement can be performed on the point cloud, the quality enhancement problem of the three-dimensional point cloud is converted into the quality enhancement problem of the two-dimensional pictures by utilizing the depth learning method for the quality enhancement of the two-dimensional pictures, and a solution for the quality enhancement in the three-dimensional space is provided. For example, in the encoding condition of lossless geometry and lossy color under the TMC13 encoding framework, quality enhancement can be performed on color attribute data of the decoded point cloud.

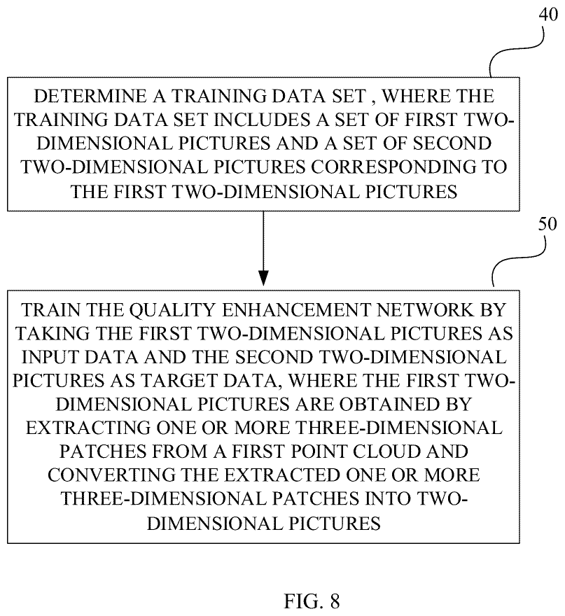

A method for determining a parameter of a quality enhancement network (which can also be regarded as a training method for the quality enhancement network) is further provided in an embodiment of the disclosure. As illustrated in FIG. 8, the method includes the following. At block 40, a training data set is determined, where the training data set includes a set of first two-dimensional pictures and a set of second two-dimensional pictures corresponding to the first two-dimensional pictures. At block 50, the quality enhancement network is trained by taking the first two-dimensional pictures as input data and the second two-dimensional pictures as target data, and the parameter of the quality enhancement network is determined. The first two-dimensional pictures are obtained by extracting one or more three-dimensional patches from a first point cloud and converting the extracted one or more three-dimensional patches into two-dimensional pictures, the first point cloud includes attribute data and geometry data, attribute data of the first two-dimensional pictures is extracted from attribute data of the first point cloud, and attribute data of the second two-dimensional pictures is extracted from attribute data of a second point cloud, where the first point cloud is different from the second point cloud.

In an embodiment of the disclosure, the quality enhancement network is a convolution neural network, such as a convolution neural network based on deep learning, which is used for performing quality enhancement on the attribute data of the point cloud. The convolution neural network generally includes an input layer, a convolution layer, a down-sampling layer, a fully connected layer, and an output layer. The parameter of the convolution neural network includes common parameters such as weights and offsets of the convolution layer and fully connected layer, and can also include super parameters such as number of layers and learning rate. The parameter of the convolution neural network can be determined by training the convolution neural network. As an example, the training process of the convolution neural network includes two stages. The first stage is a stage of propagation of data from the low layer to the high layer, that is, the forward propagation stage. The other stage is a stage of propagation of error from the high layer to the low layer for training when the results obtained from the forward propagation are inconsistent with expectations, that is, the back propagation stage. As an example, the training process of the convolution neural network is as follows. At step 1, the network initializes weights. At step 2, after the input data is subject to the forward propagation of the convolution layer, the down sampling layer, and the fully connected layer, the output data (such as the output value) is obtained. At step 3, the error between the output data of the network and the target data (such as the target value) is calculated. At step 4, when the error is greater than the set expected value, the error is transmitted back to the network, and the errors of the fully connected layer, the down sampling layer, and the convolution layer are obtained in turn (the error of each layer can be understood as the total error for the network borne by this layer). Execute step 5. If the error is equal to or less than the expected value, end the training. At step 5, the weight value is updated according to the obtained error. Then, proceed to step 2.

In an embodiment of the disclosure, the first point cloud is obtained by encoding and decoding the second point cloud in a training point cloud set, and the encoding is lossless encoding of geometry data and lossy encoding of attribute data. In the embodiment, the second point cloud in the training point cloud set can be regarded as the original point cloud with lossless attribute data, and thus it can be used as the target data used in the training of the quality enhancement network, so that the quality enhancement network has the quality enhancement effect on the point cloud with lossy attribute. However, the first point cloud does not need to be obtained by encoding and decoding the second point cloud. In other embodiments of the disclosure, the second point cloud may be a point cloud having one or more visual effects relative to the first point cloud, such as beauty, etc., or the second point cloud may be a point cloud obtained by other processing such as de-noising, de-blurring, etc. of the first point cloud, etc.

In an embodiment of the disclosure, attribute data of points in the first two-dimensional pictures is the same as attribute data of corresponding points in the first point cloud, attribute data of points in the second two-dimensional pictures is the same as attribute data of corresponding points in the second point cloud, and geometry data of the corresponding points in the first point cloud of the points in the first two-dimensional pictures is the same as geometry data of the corresponding points in the second point cloud of the points at same corresponding positions in the second two-dimensional pictures. For example, after the three-dimensional patch is extracted from the first point cloud and converted into two-dimensional pictures, assuming that the first point cloud is obtained by performing lossless geometry data and lossy attribute data encoding (i.e., lossless geometry and lossy attribute encoding) and decoding on the second point cloud (such as the original point cloud sequence). The geometry data of point A0 in the second point cloud is the same as that of point A1 in the first point cloud, but the attribute data may be different (or the same), and point A1 in the first point cloud is mapped to point A2 in the first two-dimensional picture. The attribute data of point A2 is the same as the attribute data of point A1. Assuming that a point at the same position in the second two-dimensional picture corresponding to the first two-dimensional picture is point A3, the corresponding point in the second point cloud of point A3 is point A0, and the attribute data of point A3 is the same as the attribute data of point A0 in the second point cloud, whereas the geometry data of the corresponding point A1 in the first point cloud of point A2 and the corresponding point A0 in the second point cloud of point A3 are the same.

In an embodiment of the disclosure, the multiple three-dimensional patches are extracted from the first point cloud as follows. Multiple representative points in the first point cloud are determined. A nearest neighbouring point for each of the multiple representative points is determined, where the nearest neighbouring point of one representative point denotes one or more points in the first point cloud nearest to the representative point. The multiple three-dimensional patches are constructed based on the multiple representative points and the nearest neighbouring points of the multiple representative points. The process of extracting the multiple three-dimensional patches from the point cloud in the embodiment may be the same as the process of extracting the multiple three-dimensional patches from the point cloud described in the previous other embodiments of the disclosure, which is not repeated herein.

In an embodiment of the disclosure, the extracted multiple three-dimensional patches are converted into two-dimensional pictures as follows. Each extracted three-dimensional patch is converted in the following way. The representative point in the three-dimensional patch is taken as a start point, scan on a two-dimensional plane in a predetermined scan mode, and other points in the three-dimensional patch are mapped to a scan path in an increasing order of Euclidean distances to the representative point, to obtain one or more two-dimensional pictures, where a point in the three-dimensional patch nearer to the representative point is nearer to the representative point on the scan path, and attribute data of all points after mapping are unchanged. In one example, the three-dimensional patch includes S1×S2 points, where S1 and S2 are positive integers greater than or equal to 2. The predetermined scan mode includes at least one of: square-spiral-shape scan, raster scan, or Z-shape scan, which are described in detail above. When there are multiple predetermined scan modes, multiple two-dimensional pictures determined according to the multiple predetermined scan modes are used as the input data. The training data set can be expanded and better training results can be achieved.

In an embodiment of the disclosure, the quality enhancement network corresponds to a point cloud of a type. The training data set is determined as follows. The training data set of the quality enhancement network is determined with data of the point cloud of the type. In this way, different quality enhancement networks can be trained for point clouds of different types, which is more targeted and can improve the quality enhancement effect of the point clouds.

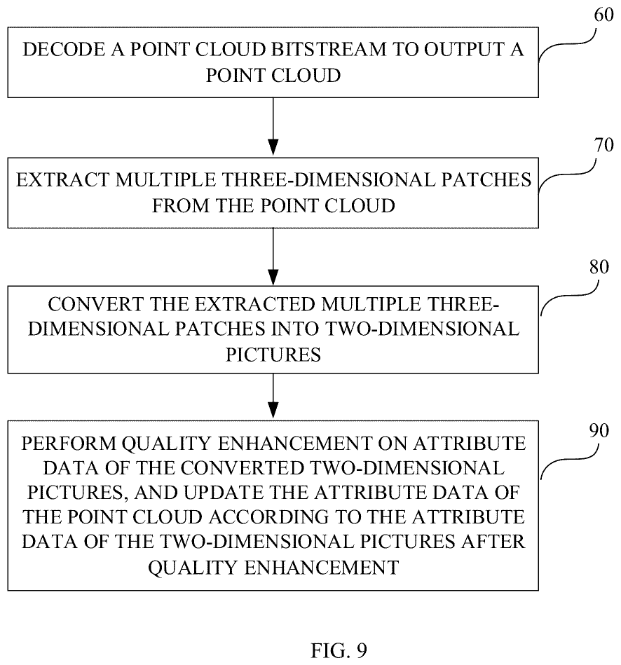

A point cloud decoding method is further provided in an embodiment of the disclosure. As illustrated in FIG. 9, the method includes the following.

At block 60, a point cloud bitstream is decoded to output a point cloud.

At block 70, multiple three-dimensional patches are extracted from the point cloud.

At block 80, the extracted multiple three-dimensional patches are converted into two-dimensional pictures.

At block 90, quality enhancement is performed on attribute data of the converted two-dimensional pictures, and the attribute data of the point cloud is updated according to the attribute data of the two-dimensional pictures after quality enhancement.

In the embodiment, the attribute data contains a luma component. Quality enhancement is performed on the attribute data of the converted two-dimensional pictures, and the attribute data of the point cloud is updated according to the attribute data of the two-dimensional pictures after quality enhancement as follows. Quality enhancement is performed on luma components of the converted two-dimensional pictures, and the luma component contained in the attribute data of the point cloud is updated according to the luma components of the two-dimensional pictures after quality enhancement.

In the embodiment, the multiple three-dimensional patches are extracted from the point cloud as follows. Multiple representative points in the point cloud are determined. A nearest neighbouring point for each of the multiple representative points is determined, where the nearest neighbouring point of one representative point denotes one or more points in the point cloud nearest to the representative point. The multiple three-dimensional patches are constructed based on the multiple representative points and the nearest neighbouring points of the multiple representative points.

In the embodiment, the extracted three-dimensional patches can be converted into two-dimensional pictures as follows. Each extracted three-dimensional patch is converted in the following way. The representative point in the three-dimensional patch is taken as a start point, scan on a two-dimensional plane in a predetermined scan mode, and other points in the three-dimensional patch are mapped to a scan path in an increasing order of Euclidean distances to the representative point, to obtain one or more two-dimensional pictures, where a point in the three-dimensional patch nearer to the representative point is nearer to the representative point on the scan path, and attribute data of all points after mapping are unchanged. In one example, the predetermined scan mode includes at least one of: square-spiral-shape scan, raster scan, or Z-shape scan.

In the embodiment, the attribute data of the point cloud is updated according to the attribute data of the two-dimensional pictures after quality enhancement as follows. For each point in the point cloud, at least one corresponding point in the two-dimensional pictures after quality enhancement of the point is determined. Attribute data of the point in the point cloud is set to be equal to attribute data of the at least one corresponding point, when the number of the at least one corresponding point is equal to 1. The attribute data of the point in the point cloud is set to be equal to a weighted average value of the attribute data of the at least one corresponding point, when the number of the at least one corresponding point is greater than 1. The attribute data of the point in the point cloud is not updated, when the number of the at least one corresponding point is 0.

In the embodiment, the point cloud decoding method further includes the following. The point cloud bitstream is decoded to output at least one quality enhancement parameter of the point cloud. Quality enhancement is performed on the point cloud as follows. Quality enhancement is performed on the point cloud according to the at least one quality enhancement parameter output after decoding. The quality enhancement parameter includes at least one of: the number of the three-dimensional patches extracted from the point cloud; the number of points in each two-dimensional picture; arrangement of the points in each two-dimensional picture; at least one scan mode used when converting the multiple three-dimensional patches into the two-dimensional pictures; a parameter of a quality enhancement network, where the quality enhancement network is used for performing quality enhancement on the attribute data of the two-dimensional pictures; or a data feature parameter of the point cloud, where the data feature parameter is used for determining the quality enhancement network used in performing quality enhancement on the attribute data of the two-dimensional pictures. That is, for different data feature parameters, different quality enhancement networks can be used for quality enhancement. In an example, the data feature parameter includes at least one of: a type of the point cloud or a bit rate of an attribute bitstream of the point cloud.

In the embodiment, a part or all of the quality enhancement parameter(s) required for quality enhancement can be obtained by decoding, such as the bit rate of the attribute bitstream of the point cloud (belonging to the data feature parameter). The quality enhancement parameter that is unable to be obtained by decoding can be obtained by local detection (for example, determining the type of point cloud by detecting information such as texture complexity of the point cloud) or by configuration (for example, configuring the parameter of the quality enhancement network locally). In one example, the parameter of the quality enhancement network can also be obtained by parsing the bitstream. In the example, at least partial parameters of the quality enhancement network and other quality enhancement parameters required to be encoded are input to the point cloud encoder for encoding and then signalled into the point cloud bitstream, as illustrated in FIG. 4. The at least partial parameters of the quality enhancement network and other quality enhancement parameters required to be encoded may be stored in the point cloud data source device, for example, with the point cloud data. In the embodiment, quality enhancement is performed on the point cloud based on the quality enhancement parameters parsed from the bitstream, where the quality enhancement parameters in the bitstream may be the optimum parameters for quality enhancement on the first point cloud, which are determined by testing. The parameters and the first point cloud are encoded and signalled into the bitstream, which can solve the problem that it is difficult for the decoding end to determine the appropriate quality enhancement parameters or determine the appropriate quality enhancement parameters in real time, achieving good quality enhancement effect.

The point cloud decoding device 22 in the decoding device 2 illustrated in FIG. 4 can be used to implement the point cloud decoding method of the embodiment. In the operations at blocks 70 to 90, when quality enhancement is performed on the point cloud, quality enhancement can be performed on the point cloud according to the method for quality enhancement described in any embodiment of the disclosure.

In an example of the embodiment, in the process of performing quality enhancement on the point cloud, quality enhancement is performed on the attribute data of the converted two-dimensional pictures as follows. Quality enhancement of the attribute data of the converted two-dimensional pictures is performed with a quality enhancement network, where a parameter of the quality enhancement network is determined according to the method for determining the parameter of the quality enhancement network described in any embodiment of the disclosure. In the example, the parameter of the quality enhancement network is determined according to the following. A training data set is determined, where the training data set includes a set of first two-dimensional pictures and a set of second two-dimensional pictures corresponding to the first two-dimensional pictures. The quality enhancement network is trained by taking the first two-dimensional pictures as input data and the second two-dimensional pictures as target data, and the parameter of the quality enhancement network is determined, where the first two-dimensional pictures are obtained by extracting one or more three-dimensional patches from a first point cloud and converting the extracted one or more three-dimensional patches into two-dimensional pictures, attribute data of the first two-dimensional pictures is extracted from attribute data of the first point cloud, and attribute data of the second two-dimensional pictures is extracted from attribute data of a second point cloud, where the first point cloud is different from the second point cloud. In the example, the first point cloud is obtained by encoding and decoding the second point cloud in a training point cloud set, and the encoding is lossless encoding of geometry data and lossy encoding of attribute data; and attribute data of points in the first two-dimensional pictures is the same as attribute data of corresponding points in the first point cloud, attribute data of points in the second two-dimensional pictures is the same as attribute data of corresponding points in the second point cloud, and geometry data of the corresponding points in the first point cloud of the points in the first two-dimensional pictures is the same as geometry data of the corresponding points in the second point cloud of the points at same corresponding positions in the second two-dimensional pictures.

A point cloud decoding method is further provided in an embodiment of the disclosure. The point cloud decoding method includes the following. A point cloud bitstream is decoded to obtain a point cloud and at least one quality enhancement parameter of the point cloud, where the quality enhancement parameter is used when the decoding end performs quality enhancement on the point cloud according to the method for quality enhancement described in any embodiment of the disclosure. The quality enhancement parameter includes at least one of: the number of the three-dimensional patches extracted from the point cloud; the number of points in each two-dimensional picture; arrangement of the points in each two-dimensional picture; at least one scan mode used when converting the multiple three-dimensional patches into the two-dimensional pictures; a parameter of a quality enhancement network, where the quality enhancement network is used for performing quality enhancement on the attribute data of the two-dimensional pictures; or a data feature parameter of the point cloud, where the data feature parameter is used for determining the quality enhancement network used in performing quality enhancement on the attribute data of the two-dimensional pictures. That is, for different data feature parameters, different quality enhancement networks can be used for quality enhancement.

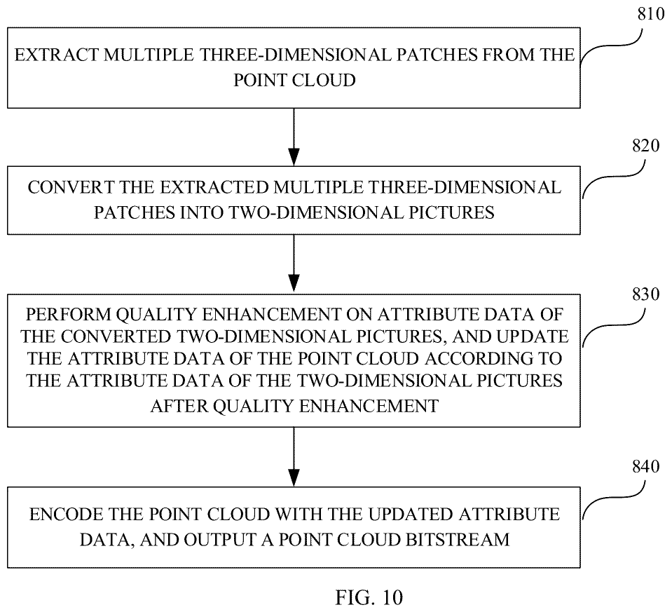

An embodiment of the disclosure further provides a point cloud encoding method. As illustrated in FIG. 10, the point cloud encoding method includes the following.

At block 810, multiple three-dimensional patches are extracted from the point cloud, where the point cloud includes attribute data and geometry data.

At block 820, the extracted multiple three-dimensional patches are converted into two-dimensional pictures.

At block 830, quality enhancement is performed on attribute data of the converted two-dimensional pictures, and the attribute data of the point cloud is updated according to the attribute data of the two-dimensional pictures after quality enhancement.

At block 840, the point cloud is encoded with the updated attribute data, and a point cloud bitstream is output.

In the operations at blocks 810 to 830, quality enhancement may be performed on the point cloud according to the method for quality enhancement of the point cloud described in any embodiment of the disclosure.

In the embodiment, the attribute data contains a luma component. Quality enhancement is performed on the attribute data of the converted two-dimensional pictures, and the attribute data of the point cloud is updated according to the attribute data of the two-dimensional pictures after quality enhancement as follows. Quality enhancement is performed on luma components of the converted two-dimensional pictures, and the luma component contained in the attribute data of the point cloud is updated according to the luma components of the two-dimensional pictures after quality enhancement.

In the embodiment, the multiple three-dimensional patches are extracted from the point cloud as follows. Multiple representative points in the point cloud are determined. A nearest neighbouring point for each of the multiple representative points is determined, where the nearest neighbouring point of one representative point denotes one or more points in the point cloud nearest to the representative point. The multiple three-dimensional patches are constructed based on the multiple representative points and the nearest neighbouring points of the multiple representative points.

In the embodiment, the extracted three-dimensional patches can be converted into two-dimensional pictures as follows. Each extracted three-dimensional patch is converted in the following way. The representative point in the three-dimensional patch is taken as a start point, scan on a two-dimensional plane in a predetermined scan mode, and other points in the three-dimensional patch are mapped to a scan path in an increasing order of Euclidean distances to the representative point, to obtain one or more two-dimensional pictures, where a point in the three-dimensional patch nearer to the representative point is nearer to the representative point on the scan path, and attribute data of all points after mapping are unchanged. In one example, the predetermined scan mode includes at least one of: square-spiral-shape scan, raster scan, or Z-shape scan.

In the embodiment, the attribute data of the point cloud is updated according to the attribute data of the two-dimensional pictures after quality enhancement as follows. For each point in the point cloud, at least one corresponding point in the two-dimensional pictures after quality enhancement of the point is determined. Attribute data of the point in the point cloud is set to be equal to attribute data of the at least one corresponding point, when the number of the at least one corresponding point is 1. The attribute data of the point in the point cloud is set to be equal to a weighted average value of the attribute data of the at least one corresponding point, when the number of the at least one corresponding point is greater than 1. The attribute data of the point in the point cloud is not updated, when the number of the at least one corresponding point is 0.

In the embodiment, the point cloud encoding method further includes the following. A first quality enhancement parameter of the point cloud is determined, and quality enhancement is performed on the point cloud according to the determined first quality enhancement parameter. The quality enhancement parameter includes at least one of: the number of the three-dimensional patches extracted from the point cloud; the number of points in each two-dimensional picture; arrangement of the points in each two-dimensional picture; at least one scan mode used when converting the multiple three-dimensional patches into the two-dimensional pictures; a parameter of a quality enhancement network, where the quality enhancement network is used for performing quality enhancement on the attribute data of the two-dimensional pictures; or a data feature parameter of the point cloud, where the data feature parameter is used for determining the quality enhancement network used in performing quality enhancement on the attribute data of the two-dimensional pictures. The data feature parameter includes at least one of: a type of the point cloud or a bit rate of an attribute bitstream of the point cloud. In an example, at least one of the first quality enhancement parameter is obtained from a point cloud data source device of the point cloud.

In the embodiment, the point cloud encoding method further includes the following. A second quality enhancement parameter is obtained. The second quality enhancement parameter is encoded and the second quality enhancement parameter is signalled into the point cloud bitstream, where the second quality enhancement parameter is used when a decoding end performs quality enhancement on the point cloud output after decoding the point cloud bitstream. The second quality enhancement parameter may be obtained from a point cloud data source device or other devices.

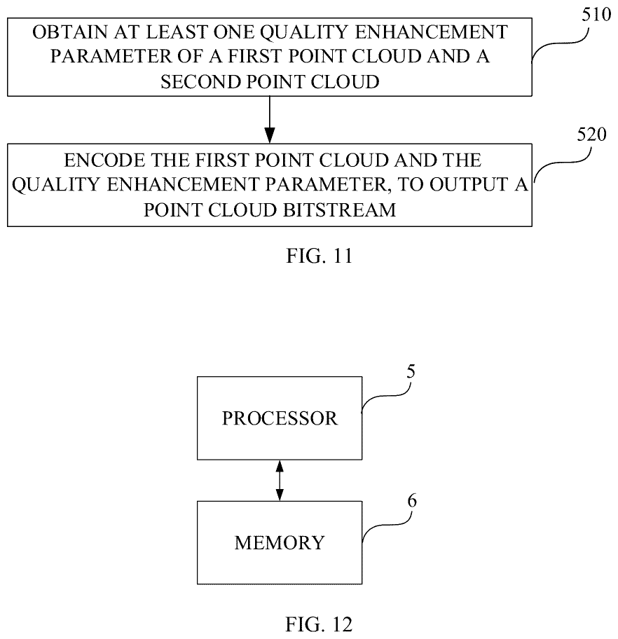

A point cloud encoding method is further provided in an embodiment of the disclosure. As illustrated in FIG. 11, the point cloud encoding method includes the following. At block 510, at least one quality enhancement parameter of a first point cloud and a second point cloud is obtained. At block 520, the first point cloud and the quality enhancement parameter are encoded, to output a point cloud bitstream. The quality enhancement parameter is used when the decoding end performs quality enhancement on the second point cloud according to the method for quality enhancement described in any embodiment of the disclosure, and the second point cloud is a point cloud output from the decoding end after decoding the point cloud bitstream.

A device for quality enhancement of a point cloud is further provided in an embodiment of the disclosure. As illustrated in FIG. 12, the device for quality enhancement of the point cloud includes a processor 5 and a memory 6 storing a computer program executable on the processor. The processor 5 implements the method for quality enhancement as described in any embodiment of the disclosure when executing the computer program.

A device for determining a parameter of a quality enhancement network is further provided in an embodiment of the disclosure. As illustrated in FIG. 12, the device for determining the parameter of the quality enhancement network includes a processor and a memory storing a computer program executable on the processor. The processor implements the method for determining the parameter of the quality enhancement network as described in any embodiment of the disclosure when executing the computer program.

A point cloud decoding device is further provided in an embodiment of the disclosure. As illustrated in FIG. 12. The point cloud decoding device includes a processor and a memory storing a computer program executable on the processor. The processor implements the point cloud decoding method as described in any embodiment of the disclosure when executing the computer program.

A point cloud encoding device is further provided in an embodiment of the disclosure. As illustrated in FIG. 12, the point cloud encoding device includes a processor and a memory storing a computer program executable on the processor. The processor implements the point cloud encoding method as described in any embodiment of the disclosure when executing the computer program.

A non-transitory computer-readable storage medium is further provided in an embodiment of the disclosure. The computer-readable storage medium stores a computer program, where when the computer program is executed by a processor, the method as described in any embodiment of the disclosure is implemented.

A point cloud bitstream is further provided in an embodiment of the disclosure. The bitstream is generated according to the encoding method described in any embodiment of the disclosure, where the bitstream includes parameter information required for quality enhancement of a second point cloud, and the second point cloud is a point cloud output from a decoding end after decoding the point cloud bitstream.

For the encoding mode of lossless geometry and lossy color under the point cloud standard encoding platform TMC (such as TMC13v9.0) given by MPEG, an embodiment of the disclosure provides a method for quality enhancement, aiming at data recovery of a distorted point cloud at a decoding end. The TMC13v9.0 encoding platform provides six bit-rate points, which are r01˜r06, and the corresponding color quantization steps are 51, 46, 40, 34, 28, and 22 respectively. In the embodiment, first, the original point cloud sequence is encoded and decoded at r01 bit rate, and the value of its luma component, that is, the Y value, is extracted. Then, training data sets are made for point clouds of different types, and sent to the quality enhancement network corresponding to its type for training. In the test stage, the trained quality enhancement network is used to perform quality enhancement on other point cloud sequences with encoding distortion (i.e., lossy color) at r01 bit rate.

Making Training Data Set

From all the test sequences given by MPEG, point cloud sequences with color attribute information are selected, and then by evaluating the texture complexity of each point cloud sequence, the sequences are divided into building type and portrait type for training and testing, respectively.

Due to the irregular distribution of the three-dimensional point cloud in the three-dimensional space, to better extract its feature in the neural network, in the embodiment, the three-dimensional patch(s) is extracted from the point cloud for training and testing, and the patch is converted into the two-dimensional picture(s) and then sent to the convolution neural network for training. Specifically, for the point cloud sequences used for training in the above two types (i.e., the original point cloud sequence), after the point cloud sequences with lossy color is obtained through lossless geometry and lossy color encoding and decoding, pointNum representative points are collected from each point cloud sequence with lossy color through FPS algorithm, where pointNum is the set number of representative points contained in each sequence. In the embodiment, pointNum=256, but the disclosure is not limited to this, which can also be 128, 512, 1024, and other set values. Then, find out S×S−1 points nearest to each representative point in Euclidean distance, to form a patch including S×S points, and extract Y values of all points in the patch from the attribute data of the point cloud. Thereafter, the extracted patches are respectively converted into two-dimensional pictures of S×S.

In the embodiment, the number of points contained in the patch is set to 1024, i.e., the data in the patch is finally converted into the two-dimensional form of 32×32 and then sent to the quality enhancement network. When the patch composed of 1024 points is converted into the two-dimensional pictures, in the embodiment, two scan modes: a square-spiral-shape scan mode and a raster scan mode are adopted, but in other embodiments, one scan mode is adopted. The two scan modes also represent two arrangement modes in which points in patch are mapped into two-dimensional pictures. The square-spiral-shape scan mode is illustrated in FIG. 7A, and the raster scan mode is illustrated in FIG. 7B. As illustrated in the figure, the start point of each arrangement mode is a representative point (a small box with the number 1). When scanning on a two-dimensional region, points in the patch other than the representative point are mapped to the scan path in an increasing order of Euclidean distances to the representative point, to obtain the two-dimensional picture, where a point in the patch nearer to the representative point is nearer to the representative point on the scan path in the two-dimensional picture, and attribute data of all points after mapping are unchanged. In the embodiment, each patch is converted in the two scan modes, which is equivalent to data augmentation, improving the training effect.

The converted two-dimensional picture (referred to above as the first two-dimensional picture) is used as input data for use in training, and the two-dimensional picture (referred to above as the second two-dimensional picture) used as target data in training is obtained by using attribute data (e.g. Y values) of all points in the converted two-dimensional picture to replace attribute data (i.e., true values of attributes) of corresponding points in the original point cloud sequence of the points. Assuming that point A2 in the converted two-dimensional picture is obtained from mapping of point A1 in the three-dimensional patch extracted from the point cloud sequence with lossy color, the corresponding point (point A0) in the original point cloud sequence of point A2 has the same geometry data or the same geometry position as point A1, and the attribute data of point A0 represents the true value of the attribute.

Building and Training Neural Network

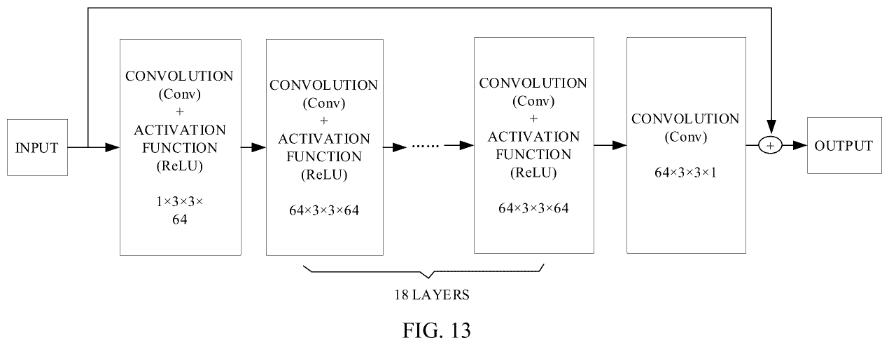

In the embodiment, a convolution neural network is adopted as the quality enhancement network, and the convolution neural network is provided with N convolution layers in total, where N=20, but the disclosure is not limited thereto, for example, N≥10. Except for the last convolution layer, for other layers, the activation function is added after each convolution layer, and the skip connection is added to speed up network training. The schematic structural diagram of the convolution neural network is illustrated in FIG. 13. When training, the initial learning rate of the convolution neural network is set to 5e-4 and the learning rate is adjusted at equal intervals, and the selected optimizer is the commonly used Adam algorithm. Through training, the parameters such as weight and offset used in the convolution neural network can be determined. In other embodiments, parameters such as the number of layers and learning rate of the convolution neural network can also be adjusted by verifying the data set.

Model Testing

In the test stage, the type of point cloud is determined according to the texture complexity of the test sequence, and the quality enhancement network corresponding to the type is selected for testing. Specifically, for the original point cloud sequence used for testing, first, the point cloud sequence with lossy color is obtained by lossy encoding and decoding, multiple patches are extracted from the point cloud sequence with lossy color in the way of making the data set, and then converted into two-dimensional pictures respectively, and the converted two-dimensional pictures are sent to the trained convolution neural network for quality enhancement. For the point used repeatedly in different patches, the weighted average value of the attribute data of multiple corresponding points in the quality-enhanced two-dimensional pictures of the point can be taken as the quality-enhanced attribute data of the point. For the point not extracted from all patches, the attribute data in the point cloud sequence with lossy color of the point can be kept unchanged. As such, the final quality-enhanced three-dimensional point cloud data is obtained.

The method of the embodiment is performed on the point cloud encoding platform TMC13v9.0 provided by MPEG. When encoding, lossless geometry and lossy color attribute encoding is selected, and color attribute encoding mode is region adaptive hierarchical transform (RAHT). When the selected bit-rate point is 1-01, the test result indicates that: for three test sequences selected for the training model of the building type, after quality enhancement is performed on the decoded point cloud with lossy color with the convolution neural network, compared with the PSNR values of the luma components when the quality enhancement is not performed, the PSNR values of the luma components are increased by 0.14 dB, 0.13 dB, and 0.09 dB respectively. For four sequences selected for the training model of the portrait type, after quality enhancement, the PSNR values of the luma components are increased by 0.28 dB, 0.17 dB, 0.32 dB, and 0.10 dB respectively, that is, the PSNR value of the luma component is increased by 0.18 dB on average at r01 bit rate, and the quality enhancement effect is achieved.

In addition, in the embodiment, at r02, r03, and r04 bit-rate points, one convolutional neural network for quality enhancement of the point cloud is trained for each bit rate, and testing is also performed. The test results indicate that: the PSNR value at r02 bit rate is improved by 0.19 dB on average, the PSNR value at r03 bit rate is improved by 0.17 dB on average, and the PSNR value at r04 bit rate is improved by 0.1 on average. This data indicates that, in the embodiment of the disclosure, the point cloud quality after lossy encoding can be improved.

In the embodiment of the disclosure, quality enhancement is performed on the lossy point cloud data obtained in the lossless geometry and lossy color encoding condition under the TMC13 encoding framework, the existing application of the depth learning method to the quality enhancement task of the two-dimensional picture, the quality enhancement problem of the three-dimensional point cloud is converted into that of the two-dimensional pictures, as the solution for quality enhancement in the three-dimensional space, and a network framework capable of quality enhancement is proposed. In the embodiment of the disclosure, the network for quality enhancement of the point cloud can be obtained by improving the network like de-noising, de-blurring, and up-sampling popular in two-dimensional pictures at present.

In the embodiment of the disclosure, regarding the training data set adopted, the point cloud sequence(s) with color selected from the current three-dimensional point cloud database in the deep learning field can be appropriately expanded, where more data sets can bring better gains. That is, the training point cloud set includes at least one of: a set of point clouds (or point cloud sequences) with color attributes given by MPEG, or a set of point clouds (or point cloud sequences) with color attributes in the point cloud database used in the deep learning field.

In one or more embodiments, the described functionality may be implemented in hardware software firmware or any combination thereof. If implemented in software, the function as one or more instructions or codes may be stored on or transmitted via a computer-readable medium and executed by a hardware-based processing unit. The computer-readable medium may include a computer-readable storage medium corresponding to a tangible medium, such as a data storage medium, or a communication medium that includes any medium that facilitates the transfer of a computer program from one place to another, such as in accordance with a communication protocol. In this manner, the computer-readable medium may generally correspond to a non-transitory tangible computer-readable storage medium or a communication medium such as a signal or carrier wave. The data storage medium may be any available medium accessible by one or more computers or one or more processors to retrieve instructions, codes, and/or data structures for implementing the techniques described in the disclosure. The computer program product may include a computer readable medium.

By way of example rather than limitation, such computer-readable storage media may include random access memory (RAM), read only memory (ROM), electrically erasable programmable read only memory (EEPROM), compact discs-ROM (CD-ROM) or other optical disk storage, disk storage or other magnetic storage, flash memory, or any other medium that may be used to store desired program code in the form of instructions or data structures and that may be accessed by a computer. Furthermore, any connection may also be referred to as a computer-readable medium. For example, if instructions are transmitted from a Web site, server, or other remote source using coaxial cable, fiber optic cable, twisted pair, digital subscriber line (DSL), or wireless technologies such as infrared, radio, and microwave, coaxial cable, fiber optic cable, double rib, DSL, or wireless technologies such as infrared, radio, and microwave are included in the definition of the medium. However, it should be understood that computer-readable storage media and data storage media do not contain connections, carriers, signals, or other transitory (volatile) media, but are intended for non-transitory tangible storage media. As used herein, magnetic disks and optical discs include CD, laser discs, optical discs, digital versatile discs (DVD), floppy discs or Blu-ray discs, etc., where magnetic discs generally reproduce data magnetically, while optical discs reproduce data optically using lasers. The above combination should also be included in the scope of computer readable media.

The instructions may be executed by one or more processors, such as one or more digital signal processors (DSP), general purpose microprocessors, application specific integrated circuit (ASIC) field programmable logic arrays (FPGA), or other equivalent integrated or discrete logic circuits. Thus the term “processor” as used herein may refer to any of the above-described architectures or any other architectures suitable for implementing the techniques described herein. Additionally, in some aspects the functionality described herein may be provided within dedicated hardware and/or software modules configured for encoding and decoding or incorporated in a combined codec. Furthermore, the techniques may be fully implemented in one or more circuits or logic elements.

The embodiment of the disclosure may be implemented in a wide variety of devices or devices including a wireless handset an integrated circuit (IC) or a set of ICs (e.g. a chipset). Various components modules or units are depicted in embodiments of the disclosure to emphasize functional aspects of an apparatus configured to perform the described techniques but are not necessarily implemented by different hardware units. Rather, as described above, the various units may be combined in a codec hardware unit or provided by a set of interoperable hardware units (including one or more processors as described above) in combination with suitable software and/or firmware.

Those of ordinary skill in the art will appreciate that all or some of the steps, systems, functional modules/units in the above disclosed methods may be implemented as software, firmware, hardware, and appropriate combinations thereof. In hardware embodiments the division between functional modules/units mentioned in the above description does not necessarily correspond to the division of physical components; For example, a physical component may have multiple functions or a function or step may be performed cooperatively by several physical components. Some or all of the components may be implemented as software executed by a processor, such as a digital signal processor or a microprocessor, or as hardware, or as an integrated circuit, such as an application specific integrated circuit. Such software may be distributed on computer-readable media, which may include computer storage media (or non-transitory media) and communication media (or transitory media). As is well known to those of ordinary skill in the art, the term “computer storage medium” includes transitory and non-transitory, removable and non-removable media implemented in any method or technique for storing information, such as computer-readable instructions, data structures, program modules, or other data. The computer storage media include, but are not limited to, RAM, ROM, EEPROM, flash memory or other memory technology, CD-ROM, DVD, or other optical disk storage, magnetic cartridges, magnetic tapes, magnetic disk storage or other magnetic storage devices, or any other media that may be used to store desired information and may be accessed by a computer. In addition, it is well known to those of ordinary skill in the art that communication media typically contain computer readable instructions, data structures, program modules, or other data in modulated data signals such as carrier waves or other transmission mechanisms, and may include any information delivery medium.

What is claimed is:

1. A point cloud decoding method, comprising:
decoding a point cloud bitstream to output a point cloud, the point cloud comprising attribute data and geometry data;
extracting a plurality of three-dimensional (3D) patches from the point cloud;
converting the extracted plurality of three-dimensional patches into two-dimensional (2D) pictures; and
performing quality enhancement on attribute data of the converted two-dimensional pictures, and updating the attribute data of the point cloud according to the attribute data of the two-dimensional pictures after quality enhancement.

2. The method of claim 1, wherein:
the attribute data contains a luma component; and
performing quality enhancement on the attribute data of the converted two-dimensional pictures, and updating the attribute data of the point cloud according to the attribute data of the two-dimensional pictures after quality enhancement comprises:
performing quality enhancement on luma components of the converted two-dimensional pictures, and updating the luma component contained in the attribute data of the point cloud according to the luma components of the two-dimensional pictures after quality enhancement.

3. The method of claim 1, wherein extracting the plurality of three-dimensional patches from the point cloud comprises:
determining a plurality of representative points in the point cloud;
determining a nearest neighbouring point for each of the plurality of representative points, wherein the nearest neighbouring point of one representative point denotes one or more points in the point cloud nearest to the representative point; and
constructing the plurality of three-dimensional patches based on the plurality of representative points and the nearest neighbouring points of the plurality of representative points.

4. The method of claim 3, wherein converting the extracted plurality of three-dimensional patches into the two-dimensional pictures comprises:
converting each extracted three-dimensional patch in the following way: taking the representative point in the three-dimensional patch as a start point, scanning on a two-dimensional plane according to a predetermined scan mode, and mapping other points in the three-dimensional patch to a scan path according to an increasing order of Euclidean distances to the representative point, to obtain one or more two-dimensional pictures, wherein a point in the three-dimensional patch nearer to the representative point is nearer to the representative point on the scan path, and attribute data of all points after mapping are unchanged.

5. The method of claim 4, wherein the predetermined scan mode comprises at least one of: square-spiral-shape scan, raster scan, or Z-shape scan.

6. The method of claim 1, wherein updating the attribute data of the point cloud according to the attribute data of the two-dimensional pictures after quality enhancement comprises:
for each point in the point cloud, determining at least one corresponding point in the two-dimensional pictures after quality enhancement of the point;
setting attribute data of the point in the point cloud to be equal to attribute data of the at least one corresponding point, when the number of the at least one corresponding point is 1;
setting the attribute data of the point in the point cloud to be equal to a weighted average value of the attribute data of the at least one corresponding point, when the number of the at least one corresponding point is greater than 1; and
skipping updating the attribute data of the point in the point cloud, when the number of the at least one corresponding point is 0.

7. The method of claim 1, wherein:
the method further comprises: decoding the point cloud bitstream to output at least one quality enhancement parameter of the point cloud;
performing quality enhancement on the point cloud comprises: performing quality enhancement on the point cloud according to the at least one quality enhancement parameter output after decoding; and
the at least one quality enhancement parameter comprises at least one of:
the number of the three-dimensional patches extracted from the point cloud;
the number of points in each two-dimensional picture;
arrangement of the points in each two-dimensional picture;
at least one scan mode used when converting the plurality of three-dimensional patches into the two-dimensional pictures;
a parameter of a quality enhancement network, wherein the quality enhancement network is used for performing quality enhancement on the attribute data of the two-dimensional pictures; or
a data feature parameter of the point cloud, wherein the data feature parameter is used for determining the quality enhancement network used in performing quality enhancement on the attribute data of the two-dimensional pictures, and the data feature parameter of the point cloud comprises at least one of: a type of the point cloud or a bit rate of an attribute bitstream of the point cloud.

8. The method of claim 1, wherein:
performing quality enhancement on the attribute data of the converted two-dimensional pictures comprises: performing quality enhancement of the attribute data of the converted two-dimensional pictures with a quality enhancement network, wherein a parameter of the quality enhancement network is determined according to the following:
determining a training data set, wherein the training data set comprises a set of first two-dimensional pictures and a set of second two-dimensional pictures corresponding to the first two-dimensional pictures; and
training the quality enhancement network by taking the first two-dimensional pictures as input data and the second two-dimensional pictures as target data, and determining the parameter of the quality enhancement network,
wherein the first two-dimensional pictures are obtained by extracting one or more three-dimensional patches from a first point cloud and converting the extracted one or more three-dimensional patches into two-dimensional pictures, attribute data of the first two-dimensional pictures is extracted from attribute data of the first point cloud, and attribute data of the second two-dimensional pictures is extracted from attribute data of a second point cloud, wherein the first point cloud is different from the second point cloud.

9. The method of claim 8, wherein:
the first point cloud is obtained by encoding and decoding the second point cloud in a training point cloud set, and the encoding is lossless encoding of geometry data and lossy encoding of attribute data; and
attribute data of points in the first two-dimensional pictures is the same as attribute data of corresponding points in the first point cloud, attribute data of points in the second two-dimensional pictures is the same as attribute data of corresponding points in the second point cloud, and geometry data of the corresponding points in the first point cloud of the points in the first two-dimensional pictures is the same as geometry data of the corresponding points in the second point cloud of the points at same corresponding positions in the second two-dimensional pictures.

10. The method of claim 3, wherein determining the plurality of representative points in the point cloud comprises:
selecting the plurality of representative points from the point cloud with a farthest point sampling algorithm.

11. A point cloud encoding method, comprising:
extracting a plurality of three-dimensional (3D) patches from a point cloud, the point cloud comprising attribute data and geometry data;
converting the extracted plurality of three-dimensional patches into two-dimensional (2D) pictures;
performing quality enhancement on attribute data of the converted two-dimensional pictures, and updating the attribute data of the point cloud according to the attribute data of the two-dimensional pictures after quality enhancement; and
encoding the point cloud with the updated attribute data, and outputting a point cloud bitstream.

12. The method of claim 11, wherein extracting the plurality of three-dimensional patches from the point cloud comprises:
determining a plurality of representative points in the point cloud;
determining a nearest neighbouring point for each of the plurality of representative points, wherein the nearest neighbouring point of one representative point denotes one or more points in the point cloud nearest to the representative point; and
constructing the plurality of three-dimensional patches based on the plurality of representative points and the nearest neighbouring points of the plurality of representative points.

13. The method of claim 12, wherein converting the extracted plurality of three-dimensional patches into the two-dimensional pictures comprises:
converting each extracted three-dimensional patch in the following way: taking the representative point in the three-dimensional patch as a start point, scanning on a two-dimensional plane according to a predetermined scan mode, and mapping other points in the three-dimensional patch to a scan path according to an increasing order of Euclidean distances to the representative point, to obtain one or more two-dimensional pictures, wherein a point in the three-dimensional patch nearer to the representative point is nearer to the representative point on the scan path, and attribute data of all points after mapping are unchanged.

14. The method of claim 13, wherein the predetermined scan mode comprises at least one of:
square-spiral-shape scan, raster scan, or Z-shape scan.

15. The method of claim 11, wherein updating the attribute data of the point cloud according to the attribute data of the two-dimensional pictures after quality enhancement comprises:
for each point in the point cloud, determining at least one corresponding point in the two-dimensional pictures after quality enhancement of the point;
setting attribute data of the point in the point cloud to be equal to attribute data of the at least one corresponding point, when the number of the at least one corresponding point is 1;
setting the attribute data of the point in the point cloud to be equal to a weighted average value of the attribute data of the at least one corresponding point, when the number of the at least one corresponding point is greater than 1; and
skipping updating the attribute data of the point in the point cloud, when the number of the at least one corresponding point is 0.

16. The method of claim 11, wherein:
the method further comprises: determining a first quality enhancement parameter of the point cloud, and performing quality enhancement on the point cloud according to the determined first quality enhancement parameter; and
the first quality enhancement parameter comprises at least one of:
the number of the three-dimensional patches extracted from the point cloud;
the number of points in each two-dimensional picture;
arrangement of the points in each two-dimensional picture;
at least one scan mode used when converting the plurality of three-dimensional patches into the two-dimensional pictures;
a parameter of a quality enhancement network, wherein the quality enhancement network is used for performing quality enhancement on the attribute data of the two-dimensional pictures; or
a data feature parameter of the point cloud, wherein the data feature parameter is used for determining the quality enhancement network used in performing quality enhancement on the attribute data of the two-dimensional pictures, and the data feature parameter of the point cloud comprises at least one of: a type of the point cloud or a bit rate of an attribute bitstream of the point cloud.

17. The method of claim 16, wherein at least one of the first quality enhancement parameter is obtained from a point cloud data source device of the point cloud.

18. The method of claim 11, further comprising:
obtaining a second quality enhancement parameter; and
encoding the second quality enhancement parameter and signalling the second quality enhancement parameter into the point cloud bitstream,
wherein the second quality enhancement parameter is used when a decoding end performs quality enhancement on the point cloud output after decoding the point cloud bitstream.

19. The method of claim 12, wherein determining the plurality of representative points in the point cloud comprises:
selecting the plurality of representative points from the point cloud with a farthest point sampling algorithm.

20. A point cloud decoding device, comprising:
at least one processor; and
a memory coupled to the at least one processor and storing at least one computer executable instruction thereon which, when executed by the at least one processor, causes the at least one processor to:
decode a point cloud bitstream to output a point cloud, the point cloud comprising attribute data and geometry data;
extract a plurality of three-dimensional (3D) patches from the point cloud;
convert the extracted plurality of three-dimensional patches into two-dimensional (2D) pictures; and
perform quality enhancement on attribute data of the converted two-dimensional pictures, and update the attribute data of the point cloud according to the attribute data of the two-dimensional pictures after quality enhancement.
